(19) United States
(12) Patent Application Publication
(10) Pub. No.: US 2023/0168471 A1
(43) Pub. Date: Jun. 1, 2023

(54) OPTICAL SYSTEM, CAMERA MODULE, ELECTRONIC DEVICE, AND AUTOMOBILE

(71) Applicant: TIANJIN OFILM OPTO ELECTRONICS CO., LTD, Tianjin (CN)

(72) Inventors: HSIUNG-YU TSAI, TIANJIN (CN); BINLI LAN, TIANJIN (CN); DI ZHAO, TIANJIN (CN); RUI ZHOU, TIANJIN (CN)

(73) Assignee: TIANJIN OFILM OPTO ELECTRONICS CO., LTD, Tianjin (CN)

(21) Appl. No.: 17/921,105

(22) PCT Filed: Apr. 30, 2020
(86) PCT No.: PCT/CN2020/088417

§ 371 Date: Oct. 24, 2022

(51) Int. Cl. G02B 13/00; G02B 9/62; B60R 11/04

(52) U.S. Cl. CPC G02B 13/0045; G02B 9/62; B60R 11/04; G03B 17/561

(57) ABSTRACT

An optical system, sequentially comprising from an object side to an image side: a first lens having negative refractive power; a second lens having negative refractive power; a third lens having positive refractive power; a fourth lens having positive refractive power, both the object side surface and the image side surface of the fourth lens being convex; a fifth lens having negative refractive power, both the object side surface and the image side surface of the fifth lens being concave; and a sixth lens having positive refractive power, both the object side surface and the image side surface of the sixth lens being convex. The optical system satisfies the following relationship: −47<f45/f<27, wherein f45 represents a combined focal length of the fourth lens and the fifth lens, and f represents an effective focal length of the optical system.

### CROSS-REFERENCE TO RELATED APPLICATIONS

This application is a national stage application, filed under 35 U.S.C. § 371, of international patent application PCT/CN2020/088417, entitled “OPTICAL SYSTEM, CAMERA MODULE, ELECTRONIC DEVICE, AND AUTOMOBILE” filed on Apr. 30, 2020.

### TECHNICAL FIELD

The present disclosure relates to a field of cameras, particularly, to an optical system, a camera module, an electronic device, and a vehicle.

### TECHNICAL BACKGROUND

Since the application of camera lenses to electronic devices such as smartphones and tablet computers, the capturing performance of the devices has also undergone tremendous changes with the increase of users' demands for high-quality cameras. During the capturing process, the imaging quality is often degraded due to the existence of high-order aberrations, and a clear imaging picture cannot be obtained. Especially for vehicles, when the camera lens is applied to the vehicle to monitor the road information around the vehicle, the quality of the captured picture will directly affect the safety factor of the driver in using the captured picture to change lanes, reverse the vehicle, and even to be in an automatic driving state, etc.

### SUMMARY

According to various examples of the present disclosure, an optical system is provided.

An optical system includes, successively in order from an object side to an image side:

a first lens having a negative refractive power;

a second lens having a negative refractive power;

a third lens having a positive refractive power;

a fourth lens having a positive refractive power, an object side surface and an image side surface of the fourth lens being convex;

a fifth lens having a negative refractive power, an object side surface and an image side surface of the fifth lens being concave; and

a sixth lens having a positive refractive power, an object side surface and an image side surface of the sixth lens being convex;

wherein the optical system satisfies the following condition:

−47<f45/f<27;

wherein f45 is a combined focal length of the fourth lens and the fifth lens, and f is an effective focal length of the optical system.

A camera module includes a photosensitive element and the optical system as described above. The photosensitive element is arranged on the image side of the optical system.

An electronic device includes a fixing member and the camera module as described above. The camera module is arranged on the fixing member.

A vehicle includes a mounting portion and the electronic device as described above. The electronic device is arranged on the mounting portion.

Details of one or more embodiments of the present disclosure are set forth in the following drawings and descriptions. Other features, objects and advantages of the present disclosure will become apparent from the description, drawings, and claims.

### DESCRIPTION OF THE DRAWINGS

For a better description and illustration of embodiments and/or examples of the contents disclosed herein, reference can be made to one or more of the drawings. Additional details or examples used to describe the drawings should not be construed as limiting the scope of any of the disclosed contents, the currently described embodiments and/or examples, and the best mode currently understood of the contents.

FIG. 1 is a schematic view of an optical system according to a first embodiment of the present disclosure.

FIG. 2 is a graph showing longitudinal spherical aberration, astigmatism, and distortion of the optical system according to the first embodiment.

FIG. 3 is a schematic view of an optical system according to a second embodiment of the present disclosure.

FIG. 4 is a graph showing longitudinal spherical aberration, astigmatism, and distortion of the optical system according to the second embodiment.

FIG. 5 is a schematic view of an optical system according to a third embodiment of the present disclosure.

FIG. 6 is a graph showing longitudinal spherical aberration, astigmatism, and distortion of the optical system according to the third embodiment.

FIG. 7 is a schematic view of an optical system according to a fourth embodiment of the present disclosure.

FIG. 8 is a graph showing longitudinal spherical aberration, astigmatism, and distortion of the optical system according to the fourth embodiment.

FIG. 9 is a schematic view of an optical system according to a fifth embodiment of the present disclosure.

FIG. 10 is a graph showing longitudinal spherical aberration, astigmatism, and distortion of the optical system according to the fifth embodiment.

FIG. 11 is a schematic view of a camera module according to an embodiment of the present disclosure.

FIG. 12 is a schematic view of an electronic device according to an embodiment of the present disclosure.

FIG. 13 is a schematic view of a vehicle according to an embodiment of the present disclosure.

### DETAILED DESCRIPTION OF THE IMPLEMENTATIONS

In order to facilitate understanding of the present disclosure, the present disclosure will be described more fully hereinafter with reference to the related drawings. Preferred implementations of the present disclosure are shown in the drawings. However, the present disclosure can be implemented in many different forms and is not limited to the implementations described herein. Rather, the purpose of providing these implementations is to make a more thorough and comprehensive understanding of the disclosure of the present disclosure.

It should be noted that when an element is referred to as being “fixed to” another element, it can be directly on the other element or there can be an intermediate element. When one element is considered to be “connected to” another element, it can be directly connected to another element or there can be an intermediate element at the same time. As used herein, the terms “inner”, “outer”, “left”, “right”, and the like, are used for purposes of illustration only and do not illustrate the only implementation.

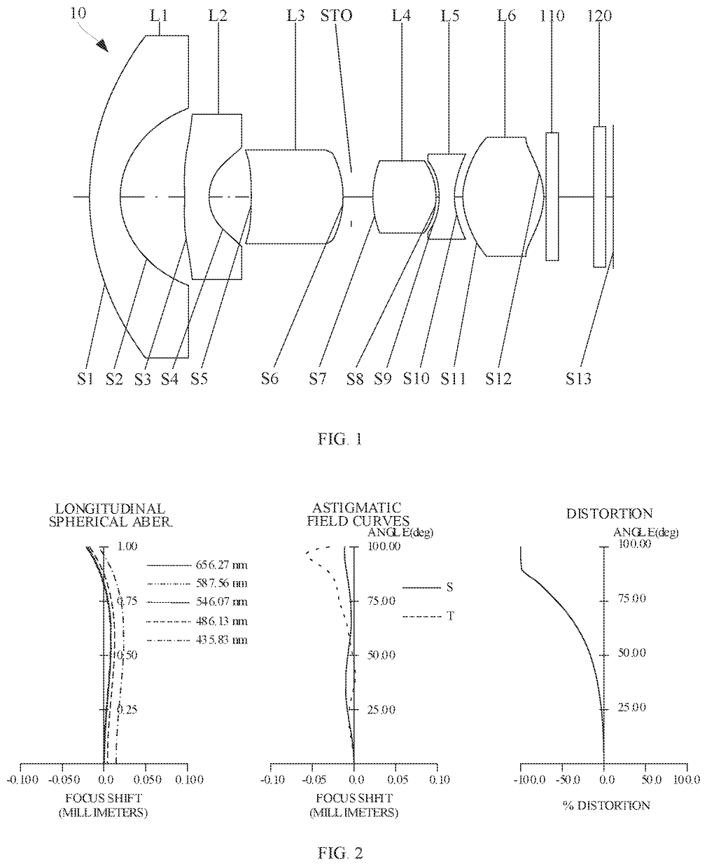

Referring to FIG. 1, some embodiments of the present disclosure provide an optical system 10. The optical system 10 includes, successively in order from an object side to an image side, a first lens L1, a second lens L2, a third lens L3, a stop STO, a fourth lens L4, a fifth lens L5, and a sixth lens L6. The first lens L1 has a negative refractive power. The second lens L2 has a negative refractive power. The third lens L3 has a positive refractive power. The fourth lens L4 has a positive refractive power. The fifth lens L5 has a negative refractive power. The sixth lens L6 has a positive refractive power. In the optical system 10, the lenses and the stop STO are coaxially disposed, that is, an optical axis of each of the lenses and a center of the stop STO are arranged on the same straight line. The straight line may be referred to as an optical axis of the optical system 10. Each of the lenses and the stop STO of the optical system 10 can be mounted on a lens barrel.

The first lens L1 includes an object side surface S1 and an image side surface S2. The second lens L2 includes an object side surface S3 and an image side surface S4. The third lens L3 includes an object side surface S5 and an image side surface S6. The fourth lens L4 includes an object side surface S7 and an image side surface S8. The fifth lens L5 includes an object side surface S9 and an image side surface S10. The sixth lens L6 includes an object side surface S11 and an image side surface S12. In addition, the optical system 10 further incudes a virtual imaging plane S13. The imaging plane S13 is arranged on an image side of the sixth lens L6. Generally, the imaging plane S13 of the optical system 10 coincides with a photosensitive surface of a photosensitive element. For the convenience of understanding, the photosensitive surface of the photosensitive element can be regarded as the imaging plane S13 of the optical system 10.

In these embodiments, the object side surface S7 of the fourth lens L4 is convex, and the image side surface S8 of the fourth lens L4 is convex. The object side surface S9 of the fifth lens L5 is concave, and the image side surface S10 of the fifth lens L5 is concave. The object side surface S11 of the sixth lens L6 is convex, and the image side surface S12 of the sixth lens L6 is convex.

In addition, the optical system 10 satisfies a condition: —47<f45/f<27; where f45 is a combined focal length of the fourth lens L4 and the fifth lens L5, and f is an effective focal length of the optical system 10. The value of f45/f in some embodiments may be −45, −43, −40, −35, −30, −10, 15, 16, 20, 21, 23, 25, or 26. When the above-mentioned refractive power configuration of the lenses, the surface shape configuration, and the condition are satisfied, it is beneficial to suppress high-order aberrations caused by edge beams, thereby effectively improving the resolution performance of the optical system 10. When the range of the condition is not satisfied, the refractive powers of the fourth lens L4 and the fifth lens L5 are insufficient to suppress high-order aberrations, coma and other phenomena, thereby reducing the resolution and imaging quality of the optical system 10.

In some embodiments, the object side surface and the image side surface of each of the lenses in the optical system 10 are aspherical, and such aspherical design can make the object side surfaces and/or the image side surfaces of the lenses have a more flexible design, so that the undesirable phenomena such as unclear imaging, distorted field of view, narrow field of view, etc., can be well eliminated even when the lenses are thinner and smaller in size. In this way, the system can have good imaging quality without arranging too many lenses, and it facilitates shortening the length of the optical system 10. In some embodiments, the object side surface and the image side surface of each of the lenses in the optical system 10 are spherical. The manufacturing process of the spherical lens is simple, and the production cost is low. Specifically, in some embodiments, the object side surfaces and the image side surfaces of the second lens L2, the third lens L3, and the sixth lens L6 are all aspherical. In other embodiments, the specific configurations of the spherical surface and the aspherical surface are determined according to actual design requirements, and which will not be repeated herein. The aberration of the system can also be effectively eliminated by the cooperation of the spherical surface and the aspherical surface, so that the optical system 10 has good imaging quality, while the flexibility of the design and assembly of the lenses is improved, so that the system can achieve a balance between high imaging quality and low cost. It should be noted that the specific shapes of the spherical surface and the aspherical surface in the embodiments are not limited to the shapes of the spherical surface and the aspherical surface shown in the accompanying drawings, which are mainly for example reference and are not scaled strictly.

For the calculation of the surface shape of the aspherical surface, reference may be made to the aspheric surface formula:

$$Z = \frac{{cr}^{2}}{1 + \sqrt{1 - ( k + 1 ) {c}^{2} {r}^{2}}} + {\sum }_{i} Ai {r}^{i}$$

where Z is a distance from a corresponding point on an aspherical surface to a plane tangent to a vertex of the surface, r is a distance from the corresponding point on the aspherical surface to the optical axis, c is the curvature of a vertex of the aspheric surface, k is a conic coefficient, and Ai is a coefficient corresponding to the i-th higher-order term in the aspheric surface formula.

In some embodiments, each of the lenses in the optical system 10 is made of plastic. In other embodiments, each of the lenses in the optical system 10 is made of glass. The lens made of plastic can reduce the weight of the optical system 10 and the manufacturing cost, while the lens made of glass can withstand higher temperatures and have excellent optical effects. In other embodiments, the first lens L1 and the fourth lens L4 are made of glass, and the other lenses in the optical system 10 are made of plastic. In this case, since the lenses arranged on the object side in the optical system 10 are made of glass, the lenses made of glass arranged on the object side have good resistance to extreme environments, and are not easily affected by the object side environment to be aged, so that when the optical system 10 is in extreme environments such as exposure to high temperatures, such structure can better balance the optical performance and cost of the system. Of course, the material configuration relationship of the lenses in the optical system 10 is not limited to the above embodiments. Any of the lenses may be made of plastic or glass, and the specific configuration relationship of the material is determined according to actual design requirements, and which will not be repeated herein.

In some embodiments, the optical system 10 includes a filter 110. The filter 110 is arranged on an image side of the sixth lens L6, and is relatively fixed with respect to each of the lenses in the optical system 10. The filter 110 is an infrared cut-off filter for filtering out infrared light, so as to prevent the infrared light from reaching the imaging plane S13 of the system, thereby preventing the infrared light from interfering with normal imaging. The filter 110 may be assembled with the lenses as part of the optical system 10. For example, in some embodiments, the lenses in the optical system 10 are mounted in the lens barrel, and the filter 110 is mounted on an image end of the lens barrel. In other embodiments, the filter 110 is not a component of the optical system 10. In this case, the filter 110 can be mounted between the optical system 10 and the photosensitive element when the optical system 10 and the photosensitive element are assembled into a camera module. In some embodiments, the filter 110 may also be arranged on an object side of the first lens L1. In addition, in some embodiments, the filter 110 may not be arranged, but an infrared filter film may be arranged on the object side surface or the image side surface of one of the first lens L1 to the sixth lens L6 to play a role of filtering the infrared light.

In some embodiments, the optical system 10 further satisfies at least one of the following conditions. When the optical system 10 satisfies any of the following conditions, the optical system 10 can have corresponding effects.

When the optical system 10 further satisfies 10<f45/f, the high-order aberration of the system can be further suppressed, so that the system has good resolution and imaging quality.

−6.5<f1/f<−3; where f1 is an effective focal length of the first lens L1, and f is the effective focal length of the optical system 10. The value of f1/f in some embodiments may be −6, −5.9, −5.7, −5.5, −5, −4.8, −4.6, or −4.5. When the above condition is satisfied, light can enter the system at a large angle, thereby enlarging the angle of field of view of the optical system 10. When the upper limit of the condition is exceeded, the focal length of the first lens L1 is too small and the refractive power of the first lens L1 is too strong, and the imaging of the system will become sensitive due to the change of the first lens, so that a large aberration is likely to occur. When the lower limit of the condition is not reached, the refractive power of the first lens L1 is insufficient, which is not beneficial to the large-angle light entering the optical system 10, and thus which is not beneficial to the wide-angle design of the system and the miniaturization of the system.

2<R4/CT2<5; where R4 is a radius of curvature of the image side surface S4 of the second lens L2 at the optical axis, and CT2 is a thickness of the second lens L2 on the optical axis. The value of R4/CT2 in some embodiments may be 2.3, 2.4, 2.5, 2.6, 2.7, 3, 3.5, 4, 4.1, or 4.2. When the above condition is satisfied, it is beneficial to control the thickness of the second lens L2 and the radius of curvature of the image side surface S4 to reduce the occurrence of ghost images, improve imaging quality, and make the system compact.

4<f3/f<6.5; where f3 is an effective focal length of the third lens L3, and f is the effective focal length of the optical system 10. The value of f3/f in some embodiments may be 4.7, 4.8, 4.9, 5, 5.5, 5.8, 5.9, 6, or 6.1. When the above condition is satisfied, the light beams diverged by the first lens L1 and the second lens L2 can be converged, and a distance between the third lens L3 and the stop STO can be reduced, thereby facilitating the miniaturization of the system. In addition, the fourth lens L4 can share the converging effect of the third lens L3 on the light, so that the surface shape of the third lens L3 will not be too curved. In this way, an angle at which the incident light is incident on the object side surface S5 and the image side surface S6 of the third lens L3 is not too large, so that it is easy to suppress the occurrence of high-order aberrations. On the other hand, after the incident light passes through the first lens L1 and the second lens L2 having strong negative refractive powers in sequence, a large curvature of field is likely to occur when the edge light is incident on the imaging plane S13, and however, through arranging the third lens L3 satisfying the above condition, it is beneficial to correct edge aberration and improve imaging resolution. If the range of the condition is not satisfied, it is disadvantageous to correct the aberration of the optical system 10, resulting in the degradation of the imaging quality.

1.5<f6/f<3; where f6 is an effective focal length of the sixth lens L6, and f is the effective focal length of the optical system 10. The value of f6/f in some embodiments may be 2.1, 2.2, 2.3, or 2.4. When the above condition is satisfied, the imaging capability of the system can be enhanced, in which the system aberration can be well corrected and the temperature sensitivity can be reduced. In addition, when the above condition is satisfied, the amount of change in back focus caused by temperature can also be reduced, so that it is beneficial to avoid defocus caused by temperature difference, thereby improving imaging quality and making the picture clearer.

11<d23/(1/f2+1/f3)<−7; where d23 is a distance from the image side surface S4 of the second lens L2 to the object side surface S5 of the third lens L3 on the optical axis; f2 is an effective focal length of the second lens L2; f3 is an effective focal length of the third lens L3; and the units of d23, f2, and f3 are all mm. The value of d23/(1/f2+1/f3) in some embodiments may be −10.3, −10.2, −10, −9.5, −9, −8.5, −8.3, −8.1, −8, or −7.9, in a numerical unit of mm². When the above condition is satisfied, the air space between the second lens L2 and the third lens L3 on the optical axis can be prevented from being too large, thereby effectively reducing the decentration sensitivity of the system, reducing the occurrence of stray light, while it is also beneficial to correct the system aberration, thereby improving the imaging quality of the system. When the air space between the second lens L2 and the third lens L3 is larger, the stray light is likely to occur, and the decentration sensitivity of the optical system is increased, and it is not beneficial to realize the miniaturization of the system.

8<(R9−R10)/(R9+R10)<6; where R9 is a radius of curvature of the object side surface S9 of the fifth lens L5 at the optical axis, and R10 is a radius of curvature of the image side surface S10 of the fifth lens L5 at the optical axis. The value of (R9−R10)/(R9+R10) in some embodiments may be −7.2, −7, −6.5, −6, −5.5, −4, −3.5, 2, 2.5, 3, 5, 5.5, or 5.8. When the above condition is satisfied, the radii of curvature of the object side surface S9 and the image side surface S10 of the fifth lens L5 can be reasonably configured, thereby reducing the risk of the occurrence of the ghost images and improving the resolution capability of the system.

When the stop STO in some embodiments is arranged between the third lens L3 and the fourth lens L4, the optical system 10 satisfies a condition: 12<TTL/d34<22; where TTL is a total optical length of the optical system 10, and d34 is a distance from the image side surface S6 of the third lens L3 to the object side surface S7 of the fourth lens L4 on the optical axis. The value of TTL/d34 in some embodiments may be 13.5, 14, 15, 16, 17, 18, 19, 20, or 21. When the above condition is satisfied, a sum of the air spaces from the stop STO to the front and rear lenses of the stop STO can be reasonably configured, thereby ensuring the uniform imaging properties of the system, reducing the phenomenon of the curvature of field, and improving the resolution capability of the imaging. Whether the imaging property is uniform is directly related to the size of the aberration. The larger the aberration is, the more uniform the imaging property is, which in turn affects the resolution capability of the imaging, which is not beneficial to the realization of high pixels of the system.

12<TTL/f<14; where TTL is the total optical length of the optical system 10, and f is the effective focal length of the optical system 10. The value of TTL/f in some embodiments may be 12.5, 12.6, 12.8, 13, 13.2, 13.3, 13.4, or 13.5. When the above condition is satisfied, the total length of the system or the focal length of the system can be prevented from being too long, which is beneficial to the design of the miniaturization of the system.

40<(FOV*f)/Imgh≤50; where FOV is the maximum angle of field of view of the optical system 10, f is the effective focal length of the optical system 10, Imgh is an image height corresponding to the maximum angle of field of view of the optical system 10; the unit of FOV is degree, and the units of f and Imgh are mm. The value of (FOV*f)/Imgh in some embodiments may be 46, 47, 48, 49, or 50, and in a numerical unit of degree. When the above condition is satisfied, it is beneficial to improve the resolution capability of the system and improve the pixel quality.

Vd4−Vd5>30; where Vd4 is the Abbe number of the fourth lens L4 under d light, and Vd5 is the Abbe number of the fifth lens L5 under d light. The value of Vd4−Vd5 in some embodiments may be 33, 35, 36, 37, 40, 43, 45, 48, or 49. When the above condition is satisfied, it is beneficial to correct the off-axis chromatic aberration, thereby improving the resolution of the system and the sharpness of the image plane.

FOV>195°; where FOV is the maximum angle of field of view of the optical system 10. When the above condition is satisfied, a sufficient angle of field of view can be provided to meet the product's demand for a large angle of field of view.

It should be noted that, when any one of the above conditions is satisfied, the optical system 10 can have the effects described by the corresponding condition.

Next, the optical system 10 of the present disclosure will be described with more specific and detailed examples:

### First Example

Referring to FIG. 1, in the first example, the optical system 10 includes, successively in order from an object side to an image side, a first lens L1 having a negative refractive power, a second lens L2 having a negative refractive power, a third lens L3 having a positive refractive power, a stop STO, a fourth lens L4 having a positive refractive power, a fifth lens L5 having a negative refractive power, and a sixth lens L6 having a positive refractive power. FIG. 2 includes a longitudinal spherical aberration diagram, an astigmatism diagram, and a distortion diagram of the optical system 10 in the first example. The reference wavelengths of the astigmatism diagrams and the distortion diagrams of the following examples (the first to fifth examples) are all 546.07 nm.

An object side surface S1 of the first lens L1 is convex, and an image side surface S2 of the first lens L1 is concave.

An object side surface S3 of the second lens L2 is concave, and an image side surface S4 of the second lens L2 is concave.

An object side surface S5 of the third lens L3 is concave, and an image side surface S6 of the third lens L3 is convex.

An object side surface S7 of the fourth lens L4 is convex, and an image side surface S8 of the fourth lens L4 is convex.

An object side surface S9 of the fifth lens L5 is concave, and an image side surface S10 of the fifth lens L5 is concave.

An object side surface S11 of the sixth lens L6 is convex, and an image side surface S12 of the sixth lens L6 is convex.

The object side surfaces and the image side surfaces of the first lens L1 and the fourth lens L4 are spherical, and the object side surfaces and the image side surfaces of the second lens L2, the third lens L3, the fifth lens L5, and the sixth lens L6 are aspherical. The aberration of the system can also be effectively eliminated by the cooperation of the spherical surface and the aspherical surface, so that the optical system 10 has good imaging quality, while the flexibility of the design and assembly of the lenses is improved, so that the system can achieve a balance between high imaging quality and low cost. In addition, the first lens L1 and the fourth lens L4 are made of glass, and the second lens L2, the third lens L3, the fifth lens L5, and the sixth lens L6 are made of plastic.

In the first example, the optical system 10 satisfies the following conditions:

f45/f=15.6; when the condition is satisfied, it is beneficial to suppress high-order aberrations caused by edge beams, thereby effectively improving the resolution performance of the optical system 10.

f1/f=−6.01; where f1 is an effective focal length of the first lens L1, and f is an effective focal length of the optical system 10. When the above condition is satisfied, light can enter the system at a large angle, thereby enlarging the angle of field of view of the optical system 10.

R4/CT2=2.695; where R4 is a radius of curvature of the image side surface S4 of the second lens L2 at an optical axis, and CT2 is a thickness of the second lens L2 on the optical axis. When the above condition is satisfied, it is beneficial to control the thickness of the second lens L2 and the radius of curvature of the image side surface S4 to reduce the occurrence of ghost images, improve imaging quality, and make the system compact.

f3/f=6.118; where f3 is an effective focal length of the third lens L3, and f is the effective focal length of the optical system 10. When the above condition is satisfied, the light beams diverged by the first lens L1 and the second lens L2 can be converged, and a distance between the third lens L3 and the stop STO can be reduced, thereby facilitating the miniaturization of the system. In addition, the fourth lens L4 can share the converging effect of the third lens L3 on the light, so that the surface shape of the third lens L3 will not be too curved. In this way, an angle at which the incident light is incident on the object side surface S5 and the image side surface S6 of the third lens L3 is not too large, so that it is easy to suppress the occurrence of high-order aberrations. On the other hand, after the incident light passes through the first lens L1 and the second lens L2 having strong negative refractive powers in sequence, a large curvature of field is likely to occur when the edge light is incident on the imaging plane S13, and however, through arranging the third lens L3 satisfying the above condition, it is beneficial to correct edge aberration and improve imaging resolution.

f6/f=2.413; where f6 is an effective focal length of the sixth lens L6, and f is the effective focal length of the optical system 10. When the above condition is satisfied, the imaging capability of the system can be enhanced, in which the system aberration can be well corrected and the temperature sensitivity can be reduced. In addition, when the above condition is satisfied, the amount of change in back focus caused by temperature can also be reduced, so that it is beneficial to avoid defocus caused by temperature difference, thereby improving imaging quality and making the picture clearer.

d23/(1/f2+1/f3)=−9.007 mm²; where d23 is a distance from the image side surface S4 of the second lens L2 to the object side surface S5 of the third lens L3 on the optical axis; f2 is an effective focal length of the second lens L2; f3 is an effective focal length of the third lens L3; and the units of d23, f2, and f3 are all mm. When the above condition is satisfied, the air space between the second lens L2 and the third lens L3 on the optical axis can be prevented from being too large, thereby effectively reducing the decentration sensitivity of the system, reducing the occurrence of stray light, while it is also beneficial to correct the system aberration, thereby improving the imaging quality of the system. When the air space between the second lens L2 and the third lens L3 is larger, the stray light is likely to occur, and the decentration sensitivity of the optical system is increased, and it is not beneficial to realize the miniaturization of the system.

(R9−R10)/(R9+R10)=5.921; where R9 is a radius of curvature of the object side surface S9 of the fifth lens L5 at the optical axis, and R10 is a radius of curvature of the image side surface S10 of the fifth lens L5 at the optical axis. When the above condition is satisfied, the radii of curvature of the object side surface S9 and the image side surface S10 of the fifth lens L5 can be reasonably configured, thereby reducing the risk of the occurrence of the ghost images and improving the resolution capability of the system.

TTL/d34=17.593; where TTL is a total optical length of the optical system 10, and d34 is a distance from the image side surface S6 of the third lens L3 to the object side surface S7 of the fourth lens L4 on the optical axis. When the above condition is satisfied, the sum of the air spaces from the stop STO to the front and rear lenses of the stop STO can be reasonably configured, thereby ensuring the uniform imaging properties of the system, reducing the phenomenon of the curvature of field, and improving the resolution capability of the imaging.

TTL/f=13.36; where TTL is the total optical length of the optical system 10, and f is the effective focal length of the optical system 10. When the above condition is satisfied, the total length of the system or the focal length of the system can be prevented from being too long, which is beneficial to the design of the miniaturization of the system.

(FOV*f)/Imgh=45.714°; where FOV is the maximum angle of field of view of the optical system 10, f is the effective focal length of the optical system 10, Imgh is an image height corresponding to the maximum angle of field of view of the optical system 10; the unit of FOV is degree, and the unit of f and Imgh is mm. When the above condition is satisfied, it is beneficial to improve the resolution capability of the system and improve the pixel quality.

Vd4−Vd5=32.805; where Vd4 is the Abbe number of the fourth lens L4 under d light, and Vd5 is the Abbe number of the fifth lens L5 under d light. When the above condition is satisfied, it is beneficial to correct the off-axis chromatic aberration, thereby improving the resolution of the system and the sharpness of the image plane.

FOV=200°; where FOV is the maximum angle of field of view of the optical system 10. When the above condition is satisfied, a sufficient angle of field of view can be provided to meet the product's demand for a large angle of field of view.

In addition, various parameters of the lenses of the optical system 10 are shown in Table 1 and Table 2. Table 2 shows the aspherical coefficients of the surfaces of the corresponding lens in Table 1, where K is the conic coefficient, and Ai is the coefficient corresponding to the i-th higher-order term in the aspheric surface formula. The elements from the object side to the image side are arranged in the order of the elements in Table 1 from top to bottom. The image plane (imaging plane S13) can be understood as a photosensitive surface of a photosensitive element when the photosensitive element is assembled later. Surface numbers 1 and 2 indicate the object side surface S1 and the image side surface S2 of the first lens L1, respectively. That is, in the same lens, a surface with a smaller surface number is the object side surface, and a surface with a larger surface number is the image side surface. The Y radius in Table 1 is a radius of curvature of the object side surface or the image side surface indicated by corresponding surface number at the optical axis. In the “thickness” parameter column of the lens, the first value is a thickness of this lens on the optical axis, and the second value is a distance from the image side surface of this lens to the object side surface of the next optical element relative to this lens on the optical axis. When the next optical element is the stop, the second value indicates a distance from the image side surface of this lens to the center of the stop on the optical axis. The value of the stop STO in the “thickness” parameter column is a distance from the center of the stop STO to the object side surface of the next lens on the optical axis. The optical axis of each of the lenses in this example of the present disclosure are arranged on the same straight line. The straight line is referred to as the optical axis of the optical system 10. The reference wavelengths of the refractive index, Abbe number, and focal length in the following examples are 546.07 nm. In addition, the relational calculation and lens structure of each example are based on the data in the parameter tables (Table 1, Table 2, Table 3, Table 4, etc.).

In the first example, the effective focal length of the optical system 10 is indicated by f, and f=1.28 mm, an f-number is indicated by FNO, and FNO=2.1, the maximum angle of field of view in a diagonal direction is indicated by FOV, and FOV=200°, the total optical length is indicated by TTL, and TTL=17.1 mm. The total optical length is a distance from the object side surface S1 of the first lens L1 to the imaging plane S13 of the system on the optical axis.

TABLE 1
First Example
f = 1.28 mm, FNO = 2.1, FOV = 200°

| Surface | Surface | Surface | Y radius | Thickness | | Refractive | Abbe | Focal Length |
|---|---|---|---|---|---|---|---|---|
| Number | Name | Shape | (mm) | (mm) | Material | index | number | (mm) |
| | Object | Spherical | Infinite | Infinite | | | | |
| | Plane | | | | | | | |
| 1 | First | Spherical | 11.756 | 1.000 | Glass | 1.773 | 49.6 | −7.673 |
| 2 | Lens | Spherical | 3.806 | 2.099 | | | | |
| 3 | Second | Aspherical | −22.374 | 0.800 | Plastic | 1.543 | 56.0 | −3.565 |
| 4 | Lens | Aspherical | 2.156 | 1.378 | | | | |
| 5 | Third | Aspherical | −20.174 | 2.996 | Plastic | 1.661 | 20.4 | 7.831 |
| 6 | Lens | Aspherical | −4.404 | 0.262 | | | | |
| | Stop | Spherical | Infinite | 0.710 | | | | |
| 7 | Fourth | Spherical | 4.565 | 2.060 | Glass | 1.694 | 53.2 | 2.799 |
| 8 | Lens | Spherical | −2.773 | 0.100 | | | | |
| 9 | Fifth | Aspherical | −3.875 | 0.500 | Plastic | 1.661 | 20.4 | −2.338 |
| 10 | Lens | Aspherical | 2.755 | 0.277 | | | | |
| 11 | Sixth | Aspherical | 2.876 | 2.637 | Plastic | 1.544 | 56.0 | 3.088 |
| 12 | Lens | Aspherical | −2.759 | 0.080 | | | | |
| | Filter | Spherical | Infinite | 0.400 | Glass | 1.523 | 54.5 | |
| | | Spherical | Infinite | 1.150 | | | | |
| | Protective | Spherical | Infinite | 0.400 | Glass | 1.523 | 54.5 | |
| | Glass | Spherical | Infinite | 0.250 | | | | |
| 13 | Image | Spherical | Infinite | 0.000 | | | | |
| | Plane | | | | | | | |

TABLE 2

| Surface | | | | |
|---|---|---|---|---|
| Number | 3 | 4 | 5 | 6 |
| K | 0.00E+00 | 0.00E+00 | 9.90E+01 | 5.13E+00 |
| A4 | 2.44E−02 | 1.42E−02 | −6.18E−03 | 7.14E−03 |
| A6 | −4.13E−03 | 1.10E−02 | 2.95E−03 | 9.77E−04 |
| A8 | 2.89E−04 | −6.99E−03 | −2.07E−03 | 6.43E−04 |
| A10 | −7.32E−06 | 6.19E−04 | 3.49E−04 | 1.08E−04 |
| A12 | 0.00E+00 | 0.00E+00 | 0.00E+00 | 0.00E+00 |
| A14 | 0.00E+00 | 0.00E+00 | 0.00E+00 | 0.00E+00 |
| A16 | 0.00E+00 | 0.00E+00 | 0.00E+00 | 0.00E+00 |
| A18 | 0.00E+00 | 0.00E+00 | 0.00E+00 | 0.00E+00 |
| A20 | 0.00E+00 | 0.00E+00 | 0.00E+00 | 0.00E+00 |
| Surface | | | | |
| Number | 10 | 11 | 12 | 13 |
| K | 0.00E+00 | 0.00E+00 | 0.00E+00 | 0.00E+00 |
| A4 | −4.49E−02 | −5.40E−02 | −2.72E−02 | 1.80E−02 |
| A6 | 1.92E−02 | 2.07E−02 | 4.69E−03 | 1.43E−03 |
| A8 | −6.64E−03 | −4.95E−03 | −4.79E−04 | −5.83E−04 |
| A10 | 8.01E−04 | 4.29E−04 | 1.31E−05 | 9.64E−05 |
| A12 | 0.00E+00 | 0.00E+00 | 0.00E+00 | 0.00E+00 |
| A14 | 0.00E+00 | 0.00E+00 | 0.00E+00 | 0.00E+00 |
| A16 | 0.00E+00 | 0.00E+00 | 0.00E+00 | 0.00E+00 |
| A18 | 0.00E+00 | 0.00E+00 | 0.00E+00 | 0.00E+00 |
| A20 | 0.00E+00 | 0.00E+00 | 0.00E+00 | 0.00E+00 |

### Second Example

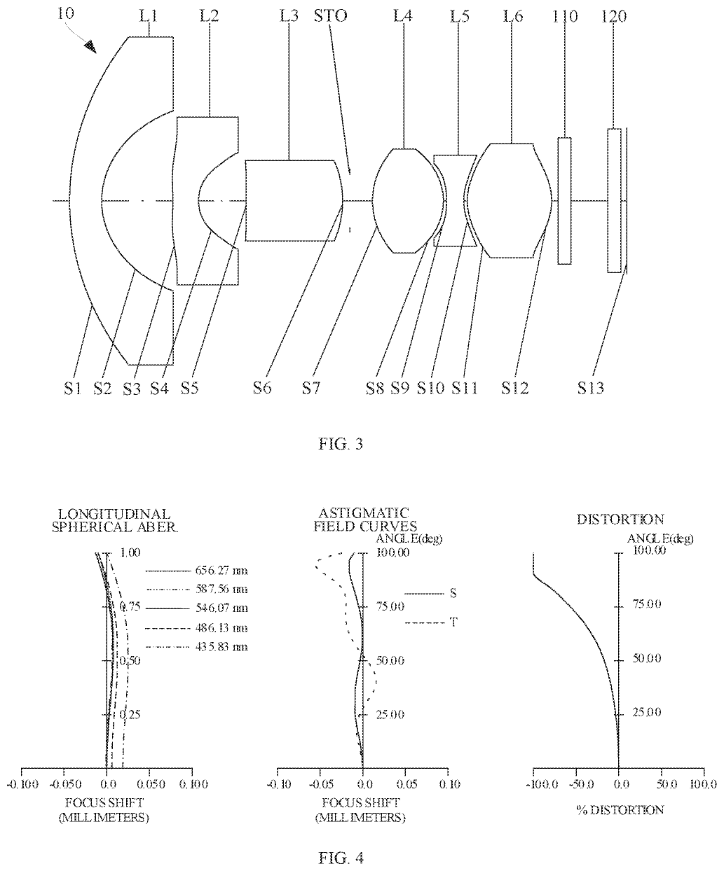

Referring to FIG. 3, in the second example, the optical system 10 includes, successively in order from an object side to an image side, a first lens L1 having a negative refractive power, a second lens L2 having a negative refractive power, a third lens L3 having a positive refractive power, a stop STO, a fourth lens L4 having a positive refractive power, a fifth lens L5 having a negative refractive power, and a sixth lens L6 having a positive refractive power. FIG. 4 includes a longitudinal spherical aberration diagram, an astigmatism diagram, and a distortion diagram of the optical system 10 in the second example.

An object side surface S1 of the first lens L1 is convex, and an image side surface S2 of the first lens L1 is concave.

An object side surface S3 of the second lens L2 is concave, and an image side surface S4 of the second lens L2 is concave.

An object side surface S5 of the third lens L3 is convex, and an image side surface S6 of the third lens L3 is convex.

An object side surface S7 of the fourth lens L4 is convex, and an image side surface S8 of the fourth lens L4 is convex.

An object side surface S9 of the fifth lens L5 is concave, and an image side surface S10 of the fifth lens L5 is concave.

An object side surface S11 of the sixth lens L6 is convex, and an image side surface S12 of the sixth lens L6 is convex.

In addition, various parameters of the lenses in the second example are shown in Table 3 and Table 4. The definitions of the structures and parameters can be obtained from the first example, and will not be repeated herein.

TABLE 3
Second Example
f = 1.28 mm, FNO = 2.1, FOV = 200°

| Surface | Surface | Surface | Y radius | Thickness | | Refractive | Abbe | Focal Length |
|---|---|---|---|---|---|---|---|---|
| Number | Name | Shape | (mm) | (mm) | Material | index | number | (mm) |
| | Object | Spherical | Infinite | Infinite | | | | |
| | Plane | | | | | | | |
| 1 | First | Spherical | 11.720 | 1.000 | Glass | 1.773 | 49.6 | −7.691 |
| 2 | Lens | Spherical | 3.808 | 2.215 | | | | |
| 3 | Second | Aspherical | −13.527 | 0.800 | Plastic | 1.536 | 56.0 | −3.117 |
| 4 | Lens | Aspherical | 1.957 | 1.485 | | | | |
| 5 | Third | Aspherical | 269.942 | 3.000 | Plastic | 1.640 | 23.5 | 7.514 |
| 6 | Lens | Aspherical | −4.922 | 0.231 | | | | |
| | Stop | Spherical | Infinite | 0.700 | | | | |
| 7 | Fourth | Spherical | 3.412 | 2.207 | Glass | 1.559 | 73.0 | 3.095 |
| 8 | Lens | Spherical | −2.711 | 0.100 | | | | |
| 9 | Fifth | Aspherical | −5.106 | 0.533 | Plastic | 1.640 | 23.5 | −2.333 |
| 10 | Lens | Aspherical | 2.226 | 0.111 | | | | |
| 11 | Sixth | Aspherical | 2.480 | 2.628 | Plastic | 1.536 | 56.0 | 2.929 |
| 12 | Lens | Aspherical | −2.729 | 0.200 | | | | |
| | Filter | Spherical | Infinite | 0.400 | Glass | 1.523 | 54.5 | |
| | | Spherical | Infinite | 1.150 | | | | |
| | Protective | Spherical | Infinite | 0.400 | Glass | 1.523 | 54.5 | |
| | Glass | Spherical | Infinite | 0.190 | | | | |
| 13 | Image | Spherical | Infinite | 0.000 | | | | |
| | Plane | | | | | | | |

TABLE 4

| Surface | | | | |
|---|---|---|---|---|
| Number | 3 | 4 | 5 | 6 |
| K | 0.00E+00 | 0.00E+00 | 9.75E+01 | 7.62E+00 |
| A4 | 3.11E−02 | 2.18E−02 | −5.26E−03 | 5.76E−03 |
| A6 | −5.83E−03 | 1.96E−02 | 5.65E−03 | 4.74E−04 |
| A8 | 4.49E−04 | −1.34E−02 | −3.98E−03 | 9.16E−04 |
| A10 | −1.26E−05 | 1.48E−03 | 7.15E−04 | 1.91E−04 |
| A12 | 0.00E+00 | 0.00E+00 | 0.00E+00 | 0.00E+00 |
| A14 | 0.00E+00 | 0.00E+00 | 0.00E+00 | 0.00E+00 |
| A16 | 0.00E+00 | 0.00E+00 | 0.00E+00 | 0.00E+00 |
| A18 | 0.00E+00 | 0.00E+00 | 0.00E+00 | 0.00E+00 |
| A20 | 0.00E+00 | 0.00E+00 | 0.00E+00 | 0.00E+00 |
| Surface | | | | |
| Number | 10 | 11 | 12 | 13 |
| K | 0.00E+00 | 0.00E+00 | 0.00E+00 | 0.00E+00 |
| A4 | −6.10E−02 | −7.96E−02 | −4.21E−02 | 1.16E−02 |
| A6 | 1.51E−02 | 2.13E−02 | 7.45E−03 | 4.24E−03 |
| A8 | −3.31E−03 | −3.93E−03 | −8.12E−04 | −1.14E−03 |
| A10 | 1.67E−04 | 1.53E−04 | −8.47E−06 | 1.55E−04 |
| A12 | 0.00E+00 | 0.00E+00 | 0.00E+00 | 0.00E+00 |
| A14 | 0.00E+00 | 0.00E+00 | 0.00E+00 | 0.00E+00 |
| A16 | 0.00E+00 | 0.00E+00 | 0.00E+00 | 0.00E+00 |
| A18 | 0.00E+00 | 0.00E+00 | 0.00E+00 | 0.00E+00 |
| A20 | 0.00E+00 | 0.00E+00 | 0.00E+00 | 0.00E+00 |

The optical system 10 in this example satisfies the following conditions:

| | | | |
|---|---|---|---|
| f1/f | −6.009 | (R9 − R10)/(R9 + R10) | 2.546 |
| R4/CT2 | 2.446 | TTL/34 | 18.636 |
| f3/f | 5.87 | TTL/f | 13.55 |
| f45/f | 20.42 | (FOV*f)/Imgh | 45.714 |
| f6/f | 2.288 | Vd4 − Vd5 | 49.462 |
| d23/(1/f2 + 1/f3) | −7.899 | | |

### Third Example

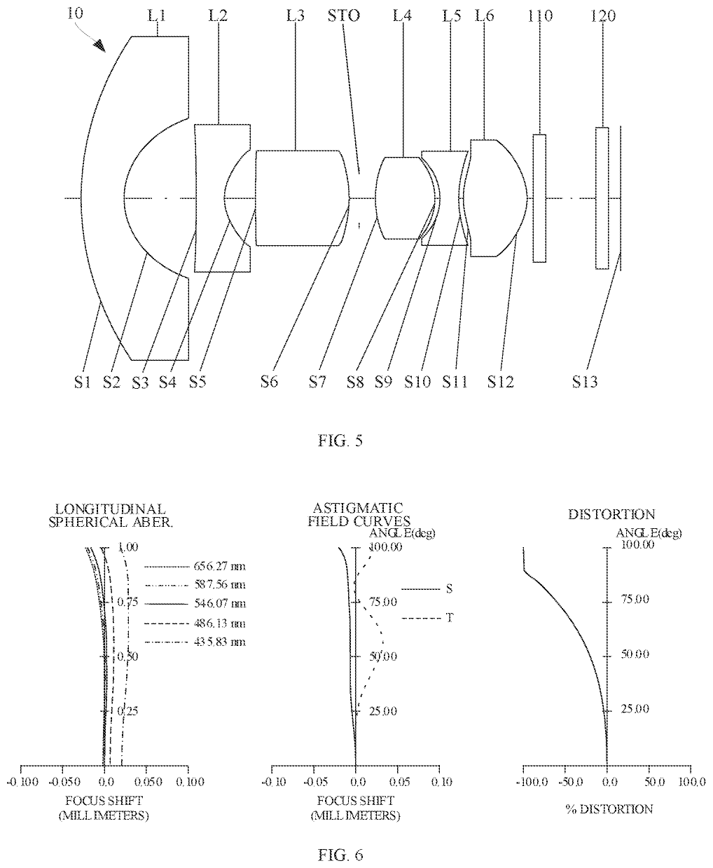

Referring to FIG. 5, in the third example, the optical system 10 includes, successively in order from an object side to an image side, a first lens L1 having a negative refractive power, a second lens L2 having a negative refractive power, a third lens L3 having a positive refractive power, a stop STO, a fourth lens L4 having a positive refractive power, a fifth lens L5 having a negative refractive power, and a sixth lens L6 having a positive refractive power. FIG. 6 includes a longitudinal spherical aberration diagram, an astigmatism diagram, and a distortion diagram of the optical system 10 in the third example.

An object side surface S1 of the first lens L1 is convex, and an image side surface S2 of the first lens L1 is concave.

An object side surface S3 of the second lens L2 is concave, and an image side surface S4 of the second lens L2 is concave.

An object side surface S5 of the third lens L3 is convex, and an image side surface S6 of the third lens L3 is convex.

An object side surface S7 of the fourth lens L4 is convex, and an image side surface S8 of the fourth lens L4 is convex.

An object side surface S9 of the fifth lens L5 is concave, and an image side surface S10 of the fifth lens L5 is concave.

An object side surface S11 of the sixth lens L6 is convex, and an image side surface S12 of the sixth lens L6 is convex.

In addition, various parameters of the lenses in the third example are shown in Table 5 and Table 6. The definitions of the structures and parameters can be obtained from the first example, and will not be repeated herein.

TABLE 5
Third Example
f = 1.40 mm, FNO = 2.1, FOV = 200°

| Surface | Surface | Surface | Y radius | Thickness | | Refractive | Abbe | Focal Length |
|---|---|---|---|---|---|---|---|---|
| Number | Name | Shape | (mm) | (mm) | Material | index | number | (mm) |
| | Object | Spherical | Infinite | Infinite | | | | |
| | Plane | | | | | | | |
| 1 | First | Spherical | 13.100 | 1.375 | Glass | 1.773 | 49.6 | −6.257 |
| 2 | Lens | Spherical | 3.381 | 2.308 | | | | |
| 3 | Second | Aspherical | −100.000 | 0.900 | Plastic | 1.540 | 56.0 | −3.714 |
| 4 | Lens | Aspherical | 2.062 | 0.992 | | | | |
| 5 | Third | Aspherical | 20.242 | 3.000 | Plastic | 1.661 | 20.4 | 6.636 |
| 6 | Lens | Aspherical | −5.345 | 0.318 | | | | |
| | Stop | Spherical | Infinite | 0.525 | | | | |
| 7 | Fourth | Aspherical | 4.988 | 1.900 | Glass | 1.690 | 53.0 | 2.814 |
| 8 | Lens | Aspherical | −2.704 | 0.161 | | | | |
| 9 | Fifth | Aspherical | −2.500 | 0.600 | Plastic | 1.661 | 20.4 | −2.298 |
| 10 | Lens | Aspherical | 4.371 | 0.150 | | | | |
| 11 | Sixth | Aspherical | 3.416 | 2.037 | Plastic | 1.540 | 56.0 | 3.090 |
| 12 | Lens | Aspherical | −2.600 | 0.200 | | | | |
| | Filter | Spherical | Infinite | 0.400 | Glass | 1.523 | 54.5 | |
| | | Spherical | Infinite | 1.600 | | | | |
| | Protective | Spherical | Infinite | 0.400 | Glass | 1.523 | 54.5 | |
| | Glass | Spherical | Infinite | 0.400 | | | | |
| 13 | Image | Spherical | Infinite | 0.000 | | | | |
| | Plane | | | | | | | |

TABLE 6

| Surface | | | | | |
|---|---|---|---|---|---|
| Number | 3 | 4 | 5 | 6 | 8 |
| K | 0.00E+00 | 0.00E+00 | 0.00E+00 | 0.00E+00 | 0.00E+00 |
| A4 | −1.64E−04 | −3.36E−02 | −1.52E−02 | 4.45E−03 | 5.84E−03 |
| A6 | 0.00E+00 | 4.45E−03 | 4.92E−03 | −1.11E−03 | 8.09E−06 |
| A8 | 0.00E+00 | −1.63E−03 | −1.37E−03 | 2.05E−03 | 0.00E+00 |
| A10 | 0.00E+00 | 1.31E−04 | 2.60E−04 | −6.39E−04 | 0.00E+00 |
| A12 | 0.00E+00 | 0.00E+00 | 0.00E+00 | 0.00E+00 | 0.00E+00 |
| A14 | 0.00E+00 | 0.00E+00 | 0.00E+00 | 0.00E+00 | 0.00E+00 |
| A16 | 0.00E+00 | 0.00E+00 | 0.00E+00 | 0.00E+00 | 0.00E+00 |
| A18 | 0.00E+00 | 0.00E+00 | 0.00E+00 | 0.00E+00 | 0.00E+00 |
| A20 | 0.00E+00 | 0.00E+00 | 0.00E+00 | 0.00E+00 | 0.00E+00 |
| Surface | | | | | |
| Number | 9 | 10 | 11 | 12 | 13 |
| K | 0.00E+00 | 0.00E+00 | 0.00E+00 | 0.00E+00 | 0.00E+00 |
| A4 | 1.01E−04 | −5.55E−03 | −1.77E−02 | −2.87E−02 | 1.58E−02 |
| A6 | 0.00E+00 | 0.00E+00 | 2.65E−03 | 2.65E−03 | −6.25E−04 |
| A8 | 0.00E+00 | 0.00E+00 | 0.00E+00 | −5.36E−04 | 0.00E+00 |
| A10 | 0.00E+00 | 0.00E+00 | 0.00E+00 | 0.00E+00 | 0.00E+00 |
| A12 | 0.00E+00 | 0.00E+00 | 0.00E+00 | 0.00E+00 | 0.00E+00 |
| A14 | 0.00E+00 | 0.00E+00 | 0.00E+00 | 0.00E+00 | 0.00E+00 |
| A16 | 0.00E+00 | 0.00E+00 | 0.00E+00 | 0.00E+00 | 0.00E+00 |
| A18 | 0.00E+00 | 0.00E+00 | 0.00E+00 | 0.00E+00 | 0.00E+00 |
| A20 | 0.00E+00 | 0.00E+00 | 0.00E+00 | 0.00E+00 | 0.00E+00 |

The optical system 10 in this example satisfies the following conditions:

| | | | |
|---|---|---|---|
| f1/f | −4.469 | (R9 − R10)/(R9 + R10) | −3.672 |
| R4/CT2 | 2.291 | TTL/34 | 20.482 |
| f3/f | 4.74 | TTL/f | 12.33 |
| f45/f | 21.94 | (FOV*f)/Imgh | 50 |
| f6/f | 2.207 | Vd4 − Vd5 | 32.6 |
| d23/(1/f2 + 1/f3) | −8.336 | | |

### Fourth Example

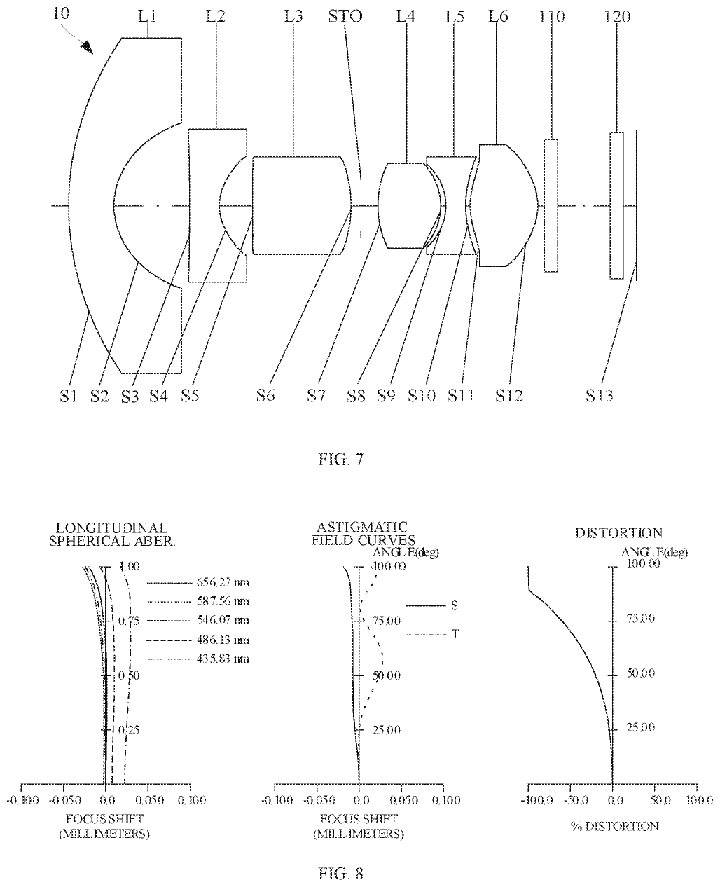

Referring to FIG. 7, in the fourth example, the optical system 10 includes, successively in order from an object side to an image side, a first lens L1 having a negative refractive power, a second lens L2 having a negative refractive power, a third lens L3 having a positive refractive power, a stop STO, a fourth lens L4 having a positive refractive power, a fifth lens L5 having a negative refractive power, and a sixth lens L6 having a positive refractive power. FIG. 8 includes a longitudinal spherical aberration diagram, an astigmatism diagram, and a distortion diagram of the optical system 10 in the fourth example.

An object side surface S1 of the first lens L1 is convex, and an image side surface S2 of the first lens L1 is concave.

An object side surface S3 of the second lens L2 is concave, and an image side surface S4 of the second lens L2 is concave.

An object side surface S5 of the third lens L3 is convex, and an image side surface S6 of the third lens is convex.

An object side surface S7 of the fourth lens L4 is convex, and an image side surface S8 of the fourth lens L4 is convex.

An object side surface S9 of the fifth lens L5 is concave, and an image side surface S10 of the fifth lens L5 is concave.

An object side surface S11 of the sixth lens L6 is convex, and an image side surface S12 of the sixth lens L6 is convex.

In addition, various parameters of the lenses in the fourth example are shown in Table 7 and Table 8. The definitions of the structures and parameters can be obtained from the first example, and will not be repeated herein.

TABLE 7
Fourth Example
f = 1.40 mm, FNO = 2.1, FOV = 200°

| Surface | Surface | Surface | Y radius | Thickness | | Refractive | Abbe | Focal Length |
|---|---|---|---|---|---|---|---|---|
| Number | Name | Shape | (mm) | (mm) | Material | index | number | (mm) |
| | Object | Spherical | Infinite | Infinite | | | | |
| | Plane | | | | | | | |
| 1 | First | Spherical | 13.100 | 1.378 | Glass | 1.773 | 49.6 | −6.268 |
| 2 | Lens | Spherical | 3.384 | 2.300 | | | | |
| 3 | Second | Aspherical | −100.000 | 0.900 | Plastic | 1.536 | 56.0 | −3.698 |
| 4 | Lens | Aspherical | 2.039 | 1.009 | | | | |
| 5 | Third | Aspherical | 22.470 | 3.000 | Plastic | 1.661 | 20.4 | 6.617 |
| 6 | Lens | Aspherical | −5.214 | 0.300 | | | | |
| | Stop | Spherical | Infinite | 0.519 | | | | |
| 7 | Fourth | Aspherical | 5.018 | 1.900 | Glass | 1.690 | 53.0 | 2.812 |
| 8 | Lens | Spherical | −2.693 | 0.160 | | | | |
| 9 | Fifth | Aspherical | −2.511 | 0.600 | Plastic | 1.661 | 20.4 | −2.255 |
| 10 | Lens | Aspherical | 4.133 | 0.140 | | | | |
| 11 | Sixth | Aspherical | 3.274 | 2.053 | Plastic | 1.536 | 56.0 | 3.065 |
| 12 | Lens | Aspherical | −2.600 | 0.200 | | | | |
| | Filter | Spherical | Infinite | 0.400 | Glass | 1.523 | 54.5 | |
| | | Spherical | Infinite | 1.600 | | | | |
| | Protective | Spherical | Infinite | 0.400 | Glass | 1.523 | 54.5 | |
| | Glass | Spherical | Infinite | 0.400 | | | | |
| 13 | Image | Spherical | Infinite | 0.000 | | | | |
| | Plane | | | | | | | |

TABLE 8

| Surface | | | | | |
|---|---|---|---|---|---|
| Number | 3 | 4 | 5 | 6 | 8 |
| K | 0.00E+00 | 0.00E+00 | 0.00E+00 | 0.00E+00 | 0.00E+00 |
| A4 | −8.04E−06 | −3.37E−02 | −1.53E−02 | 4.20E−03 | 5.84E−03 |
| A6 | 0.00E+00 | 4.30E−03 | 4.63E−03 | −6.65E−04 | 3.02E−05 |
| A8 | 0.00E+00 | −1.65E−03 | −1.23E−03 | 1.73E−03 | 0.00E+00 |
| A10 | 0.00E+00 | 1.44E−04 | 2.48E−04 | −5.87E−04 | 0.00E+00 |
| A12 | 0.00E+00 | 0.00E+00 | 0.00E+00 | 0.00E+00 | 0.00E+00 |
| A14 | 0.00E+00 | 0.00E+00 | 0.00E+00 | 0.00E+00 | 0.00E+00 |
| A16 | 0.00E+00 | 0.00E+00 | 0.00E+00 | 0.00E+00 | 0.00E+00 |
| A18 | 0.00E+00 | 0.00E+00 | 0.00E+00 | 0.00E+00 | 0.00E+00 |
| A20 | 0.00E+00 | 0.00E+00 | 0.00E+00 | 0.00E+00 | 0.00E+00 |

| Surface | | | | |
|---|---|---|---|---|
| Number | 10 | 11 | 12 | 13 |
| K | 0.00E+00 | 0.00E+00 | 0.00E+00 | 0.00E+00 |
| A4 | −6.49E−03 | −1.84E−02 | −2.82E−02 | 1.66E−02 |
| A6 | 0.00E+00 | 2.74E−03 | 2.71E−03 | −4.52E−04 |
| A8 | 0.00E+00 | 0.00E+00 | −4.68E−04 | 0.00E+00 |
| A10 | 0.00E+00 | 0.00E+00 | 0.00E+00 | 0.00E+00 |
| A12 | 0.00E+00 | 0.00E+00 | 0.00E+00 | 0.00E+00 |
| A14 | 0.00E+00 | 0.00E+00 | 0.00E+00 | 0.00E+00 |
| A16 | 0.00E+00 | 0.00E+00 | 0.00E+00 | 0.00E+00 |
| A18 | 0.00E+00 | 0.00E+00 | 0.00E+00 | 0.00E+00 |
| A20 | 0.00E+00 | 0.00E+00 | 0.00E+00 | 0.00E+00 |

The optical system 10 in this example satisfies the following conditions:

| | | | |
|---|---|---|---|
| f1/f | −4.477 | (R9 − R10)/(R9 + R10) | −4.096 |
| R4/CT2 | 2.266 | TTL/34 | 21.073 |
| f3/f | 4.726 | TTL/f | 12.33 |
| f45/f | 26.77 | (FOV*f)/Imgh | 50 |
| f6/f | 2.189 | Vd4 − Vd5 | 32.6 |
| d23/(1/f2 + 1/f3) | −8.479 | | |

### Fifth Example

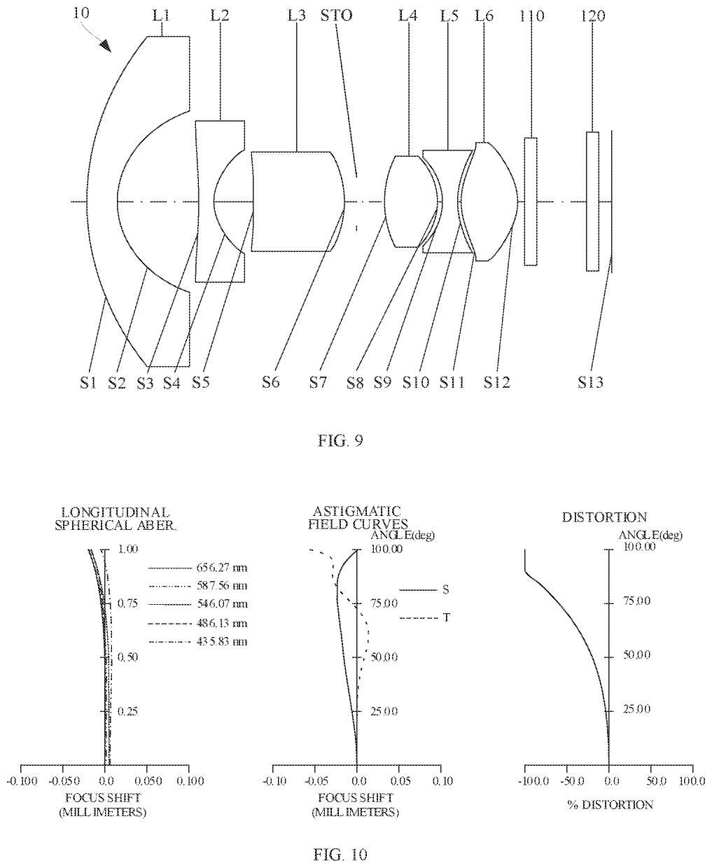

Referring to FIG. 9, in the fifth example, the optical system 10 includes, successively in order from an object side to an image side, a first lens L1 having a negative refractive power, a second lens L2 having a negative refractive power, a third lens L3 having a positive refractive power, a stop STO, a fourth lens L4 having a positive refractive power, a fifth lens L5 having a negative refractive power, and a sixth lens L6 having a positive refractive power. FIG. 10 includes a longitudinal spherical aberration diagram, an astigmatism diagram, and a distortion diagram of the optical system 10 in the fifth example.

An object side surface S1 of the first lens L1 is convex, and an image side surface S2 of the first lens L1 is concave.

An object side surface S3 of the second lens L2 is concave, and an image side surface S4 of the second lens L2 is concave.

An object side surface S5 of the third lens L3 is convex, and an image side surface S6 of the third lens is convex.

An object side surface S7 of the fourth lens L4 is convex, and an image side surface S8 of the fourth lens L4 is convex.

An object side surface S9 of the fifth lens L5 is concave, and an image side surface S10 of the fifth lens L5 is concave.

An object side surface S11 of the sixth lens L6 is convex, and an image side surface S12 of the sixth lens L6 is convex.

In addition, various parameters of the lenses in the fifth example are shown in Table 9 and Table 10. The definitions of the structures and parameters can be obtained from the first example, and will not be repeated herein.

TABLE 9
Fifth Example
f = 1.40 mm, FNO = 2.1, FOV = 200°

| Surface | Surface | Surface | Y radius | Thickness | | Refractive | Abbe | Focal Length |
|---|---|---|---|---|---|---|---|---|
| Number | Name | Shape | (mm) | (mm) | Material | index | number | (mm) |
| | Object | Spherical | Infinite | Infinite | | | | |
| | Plane | | | | | | | |
| 1 | First | Spherical | 11.720 | 1.000 | Glass | 1.773 | 49.6 | −7.966 |
| 2 | Lens | Spherical | 3.897 | 2.671 | | | | |
| 3 | Second | Aspherical | −24.669 | 0.500 | Plastic | 1.537 | 56.0 | −3.634 |
| 4 | Lens | Aspherical | 2.144 | 1.287 | | | | |
| 5 | Third | Aspherical | 43.070 | 3.000 | Plastic | 1.640 | 23.5 | 6.561 |
| 6 | Lens | Aspherical | −4.574 | 0.402 | | | | |
| | Stop | Spherical | Infinite | 0.914 | | | | |
| 7 | Fourth | Spherical | 4.758 | 1.738 | Glass | 1.620 | 60.3 | 3.158 |
| 8 | Lens | Spherical | −2.883 | 0.162 | | | | |
| 9 | Fifth | Spherical | −2.711 | 0.500 | Plastic | 1.640 | 23.5 | −2.315 |
| 10 | Lens | Aspherical | 3.579 | 0.115 | | | | |
| 11 | Sixth | Aspherical | 3.058 | 1.858 | Plastic | 1.537 | 56.0 | 2.908 |
| 12 | Lens | Aspherical | −2.533 | 0.225 | | | | |
| | Filter | Spherical | Infinite | 0.400 | Glass | 1.523 | 54.5 | |
| | | Spherical | Infinite | 1.635 | | | | |
| | Protective | Spherical | Infinite | 0.400 | Glass | 1.523 | 54.5 | |
| | Glass | Spherical | Infinite | 0.426 | | | | |
| 13 | Image | Spherical | Infinite | 0.000 | | | | |
| | Plane | | | | | | | |

TABLE 10

| Surface | | | | |
|---|---|---|---|---|
| Number | 3 | 4 | 5 | 6 |
| K | 0.00E+00 | 0.00E+00 | 0.00E+00 | 0.00E+00 |
| A4 | 1.02E−03 | −2.38E−02 | −1.31E−02 | −3.58E−04 |
| A6 | 0.00E+00 | 6.79E−04 | 1.98E−03 | −1.30E−05 |
| A8 | 0.00E+00 | −1.24E−04 | −4.92E−04 | 6.20E−04 |
| A10 | 0.00E+00 | −6.65E−05 | 1.05E−04 | −1.91E−04 |
| A12 | 0.00E+00 | 0.00E+00 | 0.00E+00 | 0.00E+00 |
| A14 | 0.00E+00 | 0.00E+00 | 0.00E+00 | 0.00E+00 |
| A16 | 0.00E+00 | 0.00E+00 | 0.00E+00 | 0.00E+00 |
| A18 | 0.00E+00 | 0.00E+00 | 0.00E+00 | 0.00E+00 |
| A20 | 0.00E+00 | 0.00E+00 | 0.00E+00 | 0.00E+00 |

| Surface | | | |
|---|---|---|---|
| Number | 11 | 12 | 13 |
| K | 0.00E+00 | 0.00E+00 | 0.00E+00 |
| A4 | −1.37E−02 | −2.39E−02 | 1.73E−02 |
| A6 | 1.39E−03 | 2.36E−03 | −5.59E−05 |
| A8 | 0.00E+00 | −2.41E−04 | 8.43E−05 |
| A10 | 0.00E+00 | −8.61E−06 | 0.00E+00 |
| A12 | 0.00E+00 | 0.00E+00 | 0.00E+00 |
| A14 | 0.00E+00 | 0.00E+00 | 0.00E+00 |
| A16 | 0.00E+00 | 0.00E+00 | 0.00E+00 |
| A18 | 0.00E+00 | 0.00E+00 | 0.00E+00 |
| A20 | 0.00E+00 | 0.00E+00 | 0.00E+00 |

The optical system 10 in this example satisfies the following conditions:

| | | | |
|---|---|---|---|
| f1/f | −5.69 | (R9 − R10)/(R9 + R10) | −7.255 |
| R4/CT2 | 4.288 | TTL/34 | 13.085 |
| f3/f | 4.686 | TTL/f | 12.31 |
| f45/f | −46.99 | (FOV*f)/Imgh | 50 |
| f6/f | 2.077 | Vd4 − Vd5 | 36.824 |
| d23/(1/f2 + 1/f3) | −10.463 | | |

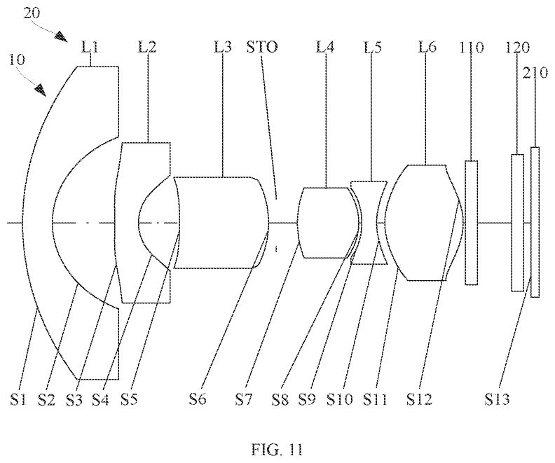

Referring to FIG. 11, some embodiments of the present disclosure further provide a camera module 20. The optical system 10 is assembled with a photosensitive element 210 to form the camera module 20. The photosensitive element 210 is arranged on the image side of the optical system 10. The photosensitive element 210 may be a charge coupled device (CCD) or a complementary metal oxide semiconductor (CMOS). Generally, when assembled, the imaging plane S13 of the optical system 10 overlaps a photosensitive surface of the photosensitive element 210.

In some embodiments, the camera module 20 includes a filter 110 arranged between the sixth lens L6 and the photosensitive element 210. The filter 110 is used to filter out infrared light. In some embodiments, the filter 110 can be mounted to an image end of the lens. In some embodiments, the camera module 20 further includes a protective glass 120. The protective glass 120 is arranged between the filter 110 and the photosensitive element 210. The protective glass 120 is used to protect the photosensitive element 210.

By using the above-mentioned optical system 10, the camera module 20 can also well suppress the occurrence of high-order aberrations, thereby having good imaging quality.

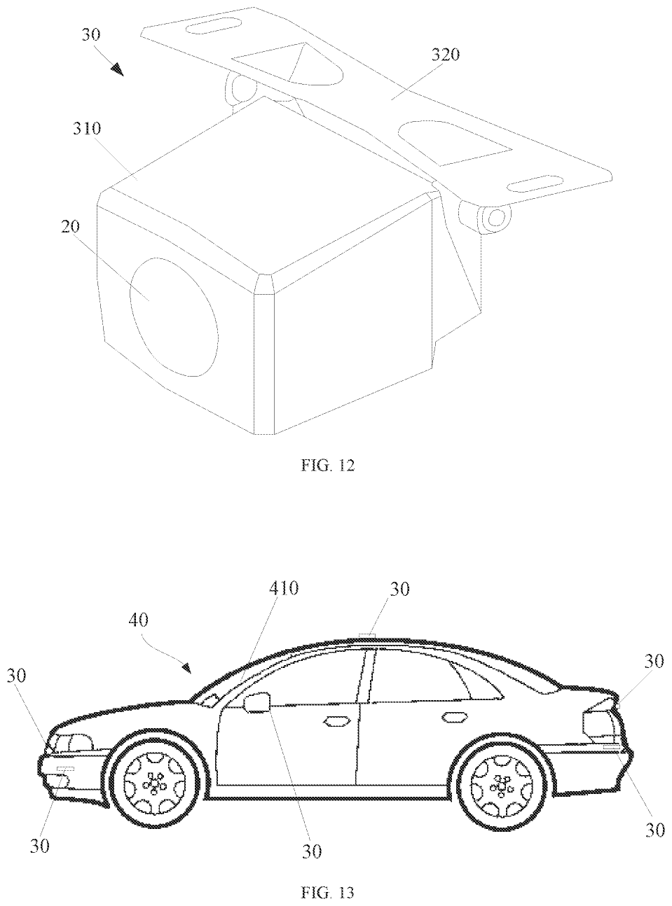

Referring to FIG. 12, some embodiments of the present disclosure further provide an electronic device 30. The camera module 20 is applied to the electronic device 30 to enable the electronic device 30 to have a camera function. Specifically, the electronic device 30 includes a fixing member 310. The camera module 20 is mounted on the fixing member 310. The fixing member 310 may be a circuit board, a middle frame, a protective housing and other components. The electronic device 30 may be, but is not limited to, a smartphone, a smart watch, an e-book reader, an in-vehicle camera device, a monitoring device, a medical device (such as an endoscope), a tablet computer, a biometric device (such as a fingerprint recognition device or a pupil recognition device etc.), a personal digital assistant (PDA), drones, etc. Specifically, in some embodiments, the electronic device 30 is a smartphone. The smartphone includes a middle frame and a circuit board. The circuit board is arranged on the middle frame. The camera module 20 is mounted on the middle frame of the smartphone, and the photosensitive element 210 therein is electrically connected to the circuit board. In other embodiments, the electronic device 30 is an in-vehicle camera device (referring to FIG. 12 for the specific structure). The camera module 20 is arranged in a housing of the in-vehicle camera device. The housing is the fixing member 310. The fixing member 310 is rotatably connected to a mounting plate 320. The mounting plate 320 is used to be fixed on a body of the vehicle. By using the above camera module 20, the electronic device 30 can have good imaging quality.

Referring to FIG. 13, some embodiments of the present disclosure further provide a vehicle 40. When the electronic device 30 is an in-vehicle camera device, the electronic device 30 can be used as a front-view camera device, a rear-view camera device, or a side-view camera device of the vehicle 40. Specifically, the vehicle 40 includes a mounting portion 410 on which the fixing member 310 of the electronic device 30 is mounted. The mounting portion 410 may be a part of the vehicle body, such as an air intake grille, side mirror, rear view mirror, trunk cover, roof, center console. When the electronic device 30 is provided with a rotatable mounting plate 320, the electronic device 30 is mounted on the mounting portion 410 of the vehicle 40 by the mounting plate 320. The electronic device 30 can be mounted at any position of the vehicle body, for example, at a front side of the vehicle body (e.g., at the air intake grille), at a left headlight, at a right headlight, at a left rearview mirror, at a right rearview mirror, at the trunk cover, at the roof, etc. Secondly, a display device can also be provided in the vehicle 40. The electronic device 30 is in communication with the display device, so that the image obtained by the electronic device 30 on the mounting portion 410 can be displayed on the display device in real time, so that the driver can obtain environmental information around the mounting portion 410 in a wider range, making it more convenient and safer for drivers to drive. By using the above electronic device 30, the influence of high-order aberrations on the imaging picture obtained by the vehicle 40 can be effectively reduced, so that the vehicle 40 can still obtain high-quality imaging pictures while driving, thereby improving driving safety. In particular, for driving modes such as automatic driving that require automatic analysis and processing of imaging pictures, the reduction of higher-order aberrations can greatly improve the accuracy of the analysis of the system, and provide more accurate guidance for the vehicle 40, thereby effectively improving the safety factor of driving modes such as automatic driving.

In the description of the present disclosure, it should be understood that the orientation or position relationship indicated by the terms “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, “axial direction”, “radial direction”, “circumferential direction” and so on is based on the orientation or position relationship shown in the drawings, which are only for the convenience of describing the present disclosure and simplifying the description, rather than indicating or implying that the device or element must have a specific orientation, or be constructed and operated in a specific orientation, so it cannot be understood as a limitation of the disclosure.

In addition, the terms such as “first” and “second” are only used for descriptive purposes and cannot be understood as indicating or implying relative importance or implicitly indicating the number of indicated technical features. Thus, the features defined with “first” and “second” may explicitly or implicitly include at least one of the features. In the description of the present disclosure, “a plurality of” means at least two, such as two, three, etc., unless otherwise expressly and specifically defined.

In the present disclosure, unless otherwise expressly specified and limited, the terms “mounting”, “connecting”, “coupling”, “fixing” and other terms should be understood in a broad sense. For example, it can be a fixed connection, a detachable connection, or an integration; it can be a mechanical connection or an electrical connection; it can be a direct connection or an indirectly connection through an intermediate medium; and it can be a connection within two elements or an interaction relationship between two elements, unless otherwise expressly limited. For those skilled in the art, the specific meaning of the above terms in the present disclosure can be understood according to the specific situation.

In the present disclosure, unless otherwise expressly specified and limited, the first feature “on” or “under” the second feature can mean that the first feature is in direct contact with the second feature, or the first feature is in indirect contact with the second feature through an intermediate medium. Moreover, the first feature is “on”, “above” or “over” the second feature can mean that the first feature is directly above or obliquely above the second feature, or it can only mean that the horizontal height of the first feature is higher than that of the second feature. The first feature is “under”, “below” or “beneath” the second feature can mean that the first feature is directly below or obliquely below the second feature, or it can only mean that the horizontal height of the first feature is less than that of the second feature.

In the description of the present specification, reference to the terms such as “an embodiment”, “some embodiments”, “an example”, “specific example”, or “some example”, etc. means that a particular feature, structure, material, or characteristic described in connection with the embodiment or example is included in at least one embodiment or example of the present disclosure. In the present specification, the illustrative expressions of the above terms are not necessarily to be directed to the same embodiment or example. Moreover, the specific features, structures, materials, or characteristics described can be combined in any one or more embodiment or example in a suitable manner. Further, in the case of no contradiction, those skilled in the art can incorporate and combine the various embodiments or examples, as well as the features of the various embodiments or examples described in the present specification.

The technical features of the above examples can be combined arbitrarily. In order to simplify the description, not all possible combinations of the technical features in the above examples are described. However, as long as there is no contradiction in the combinations of these technical features, they all should be fallen within the scope described in this specification.

The above embodiments illustrate only a few implementations of the present disclosure. Though the description thereof is rather specific and detailed, it is not to be construed as a limitation on the scope of the present disclosure. It should be noted that for those skilled in the art, several variants and improvements can be made without departing from the concept of the present disclosure, which are fallen within the protection scope of the present disclosure. Accordingly, the protection scope of the present disclosure should be subject to the appended claims.

1. An optical system, comprising, successively in order from an object side to an image side:
a first lens having a negative refractive power;
a second lens having a negative refractive power;
a third lens having a positive refractive power;
a fourth lens having a positive refractive power, an object side surface and an image side surface of the fourth lens being convex;
a fifth lens having a negative refractive power, an object side surface and an image side surface of the fifth lens being concave; and
a sixth lens having a positive refractive power, an object side surface and an image side surface of the sixth lens being convex;
wherein the optical system satisfies the following condition:
−47<f45/f<27;
wherein f45 is a combined focal length of the fourth lens and the fifth lens, and f is an effective focal length of the optical system.

2. The optical system according to claim 1, further satisfying the following condition:
−6.5<f1/f<−3;
wherein f1 is an effective focal length of the first lens.

3. The optical system according to claim 1, further satisfying the following condition:
2<R4/CT2<5;
wherein R4 is a radius of curvature of an image side surface of the second lens at an optical axis, and CT2 is a thickness of the second lens on the optical axis.

4. The optical system according to claim 1, further satisfying the following condition:
4<f3/f<6.5;
wherein f3 is an effective focal length of the third lens.

5. The optical system according to claim 1, further satisfying the following condition:
10<f45/f.

6. The optical system according to claim 1, further satisfying the following condition:
15.6<f45/f≤26.77.

7. The optical system according to claim 1, further satisfying the following condition:
1.5<f6/f<3;
wherein f6 is an effective focal length of the sixth lens.

8. The optical system according to claim 1, further satisfying the following condition:
−11<d23/(1/f2+1/f3)<−7;
wherein d23 is a distance from an image side surface of the second lens to an object side surface of the third lens on an optical axis; f2 is an effective focal length of the second lens; f3 is an effective focal length of the third lens; and units of d23, f2, and f3 are mm.

9. The optical system according to claim 1, further satisfying the following condition:
−8<(R9−R10)/(R9+R10)<6;
wherein R9 is a radius of curvature of the object side surface of the fifth lens at an optical axis, and R10 is a radius of curvature of the image side surface of the fifth lens at the optical axis.

10. The optical system according to claim 1, further comprising a stop arranged between the third lens and the fourth lens, and wherein the optical system further satisfies the following condition:
12<TTL/d34<22;
wherein TTL is a total optical length of the optical system, and d34 is a distance from an image side surface of the third lens to the object side surface of the fourth lens on an optical axis.

11. The optical system according to claim 1, further satisfying the following condition:
12<TTL/f<14;
wherein TTL is a total optical length of the optical system.

12. The optical system according to claim 1, further satisfying the following condition:
40<(FOV*f)/Imgh<50;
wherein FOV is a maximum angle of field of view of the optical system, Imgh is an image height corresponding to the maximum angle of field of view of the optical system; an unit of FOV is degree, and units of f and Imgh are mm.

13. The optical system according to claim 1, further satisfying the following condition:
Vd4−Vd5>30;
wherein Vd4 is an Abbe number of the fourth lens under d light, and Vd5 is an Abbe number of the fifth lens under d light.

14. The optical system according to claim 1, further satisfying the following condition:
FOV>195°;
wherein FOV is a maximum angle of field of view of the optical system.

15. The optical system according to claim 1, further comprising a stop arranged between the third lens and the fourth lens.

16. The optical system according to claim 1, wherein the first lens is made of glass.

17. The optical system according to claim 1, wherein an object side surface of at least one of the lenses is aspherical.

18. The optical system according to claim 1, wherein an image side surface of at least one of the lenses is aspherical.

19. A camera module, comprising:
a photosensitive element; and
the optical system according to claim 1;
wherein the photosensitive element is arranged on the image side of the optical system.

20. An electronic device, comprising:
a fixing member; and
the camera module according to claim 19;
wherein the camera module is arranged on the fixing member.

21. (canceled)
